(19) United States
(12) Patent Application Publication
(10) Pub. No.: US 2022/0366472 A1
(43) Pub. Date: Nov. 17, 2022

(54) PROVIDING ENTITY RECOMMENDATIONS FOR ITEMS

(71) Applicant: Capital One Services, LLC, McLean, VA (US)

(72) Inventors: Bryant YEE, Washington, DC (US); George BERGERON, Falls Church, VA (US); Mykhaylo BULGAKOV, Arlington, VA (US)

(21) Appl. No.: 17/302,960

(22) Filed: May 17, 2021

(51) Int. Cl. G06Q 30/06; G06N 5/04; G06F 3/0482

(52) U.S. Cl. CPC G06Q 30/0631; G06N 5/04; G06Q 30/0639; G06Q 30/0605; G06Q 30/0633; G06Q 30/0623; G06F 3/0482

(57) ABSTRACT

In some implementations, a client device may determine, using a program associated with an application that executes on the client device, a plurality of item identifiers associated with a plurality of items. The client device may identify, using the program, a combination of entities that provide the plurality of items with a reduced aggregate metric as compared to another entity or other combinations of entities from a plurality of entities. The client device may provide, via the program, a recommendation to initiate a transaction for the plurality of items from the combination of entities. The client device may initiate, via the program, the transaction for the plurality of items from the combination of entities using account information associated with each entity in the combination of entities.

### BACKGROUND

Online shopping is a form of electronic commerce which allows customers to buy items, such as goods or services, from an entity over the internet using a web browser or a mobile application. Customers may search for an item of interest by visiting a website associated with the seller and/or an electronic marketplace. The website may be displayed on a client device, such as a mobile phone or a tablet computer. Online shopping may expose customers to a wide range of different items and/or entities without the burden of traveling to brick-and-mortar retail stores.

### SUMMARY

In some implementations, a system for providing entity recommendations for items includes one or more memories and one or more processors, coupled to the one or more memories, configured to: provide, using a program associated with an application that executes on a client device, a first interface control associated with a first item, a second interface control associated with a second item, and a third interface control associated with a third item; associate the first item with a first entity, the second item with a second entity, and the third item with a third entity; receive, at the program, an indication of a selection of the first interface control, the second interface control, and the third interface control; determine, using the program, a first item identifier associated with the first item, a second item identifier associated with the second item, and a third item identifier associated with the third item; identify, using the program, a combination of entities that provide the first item, the second item, and the third item with a reduced aggregate metric as compared to another entity or other combinations of entities from a plurality of entities; determine that the combination of entities associated with the reduced aggregate metric includes one or more of the first entity, the second entity, the third entity, or one or more other entities; provide, via the program, a recommendation to initiate a transaction for the first item, the second item, and the third item from the combination of entities; and initiate, via the program, the transaction for the first item, the second item, and the third item from the combination of entities using account information associated with each entity in the combination of entities.

In some implementations, a method of providing entity recommendations for items includes determining, using a program associated with an application that executes on a client device, a plurality of item identifiers associated with a plurality of items; identifying, using the program, a combination of entities that provide the plurality of items with a reduced aggregate metric as compared to another entity or other combinations of entities from a plurality of entities; providing, via the program, a recommendation to initiate a transaction for the plurality of items from the combination of entities; and initiating, via the program, the transaction for the plurality of items from the combination of entities using account information associated with each entity in the combination of entities.

In some implementations, a non-transitory computer-readable medium storing a set of instructions includes one or more instructions that, when executed by one or more processors of a device, cause the device to: identify, using a program associated with an application that executes on a client device, an item indicated on an electronic page associated with an entity; provide, using the program, an interface control via a user interface associated with the application, wherein the interface control is associated with the item indicated on the electronic page; receive, at the program, an indication of a selection of the interface control associated with the item; determine, using the program, an item identifier associated with the item based on information describing the item on the electronic page; identify, using the program, an entity that provides the item with a reduced metric as compared to another entity from a plurality of entities; provide, via the program, a recommendation to initiate a transaction for the item from the entity; and update, using the program, the recommendation to include a plurality of items based on additional item identifiers detected via selections of interface controls associated with the additional items, wherein the recommendation indicates a combination of entities that provide the plurality of items with a reduced aggregate metric as compared to another entity or other combinations of entities from the plurality of entities.

### BRIEF DESCRIPTION OF THE DRAWINGS

FIGS. 1A-1D are diagrams of an example implementation relating to providing entity recommendations for items.

FIG. 2 is a diagram of an example environment in which systems and/or methods described herein may be implemented.

FIG. 3 is a diagram of example components of one or more devices of FIG. 2.

FIG. 4 is a flowchart of an example process relating to providing entity recommendations for items.

### DETAILED DESCRIPTION

The following detailed description of example implementations refers to the accompanying drawings. The same reference numbers in different drawings may identify the same or similar elements.

Online shopping provides customers with an ability to shop for a wide range of items from a wide variety of entities, such as merchants. Customers may purchase items from entities depending on the customer's past purchase behavior. For example, when a customer has previously purchased a specific item from one entity, the customer may be more likely to purchase that item again from the same entity. Customers may purchase items from entities depending on their perception of certain items only being offered by certain entities. For example, a customer may associate an online retail store as being favorable for certain items, such as apparel or home goods, but not for other items such as electronics. The customer may believe that electronics may be offered at a lower price and with greater variety at an online electronics store as opposed to the online retail store.

Different entities may offer different items at different prices. Customers may not compare item costs and shipping costs between multiple entities to find a reduced aggregate cost for certain items. An aggregate cost may include both an item cost and a shipping cost. As a result, customers may purchase items from one entity without realizing that another entity may offer the same item for a reduced aggregate cost.

A customer may visit a variety of websites associated with different entities when looking to purchase different items. For example, the customer may visit an online electronics store associated with a first entity to purchase a $200 microwave plus a $25 shipping fee. The customer may visit an online domestic merchandise retail store associated with a second entity to purchase a $50 trash can plus a $25 shipping fee. The customer may visit a first online retail store associated with a third entity to purchase a $100 rug with free shipping. The customer may visit a second online retail store associated with a fourth entity to purchase a $100 chair with free shipping. The customer may visit each website separately and place four separate orders with four separate entities. Each order may be associated with an aggregate cost, which may include both an aggregate item cost and an aggregate shipping cost. In this example, the aggregate item cost is $450 and the aggregate shipping cost is $50.

In some cases, the four items purchased by the customer (e.g., the microwave, the trash can, the rug, and the chair) may be available from one entity at a same item cost but with free shipping. In other words, the customer may save the $50 shipping cost by purchasing all four items from the one entity. However, the customer may not be aware that all four items are available from the one entity for the same item cost but with free shipping. In this case, the customer may pay the aggregate item cost of $450 and the aggregate shipping cost of $50 and may not benefit from the free shipping from the one entity.

The one entity may not be associated with the online electronics store, the online domestic merchandise retail store, the first online retail store, or the second online retail store. In other words, the customer may not visit a website associated with the one entity that offers the free shipping. Alternatively, the one entity may be associated with one of the online electronics store, the online domestic merchandise retail store, the first online retail store, or the second online retail store, but the customer may not be aware that all four items may be purchased from the same entity.

In some implementations described herein, to solve the problems described above, as well as a related technical problem of how to provide a customer with recommendations to purchase items from alternate entities while the customer is in the process of online shopping, a technical solution is described herein for executing a program that searches for items from a plurality of entities while the customer is in the process of online shopping and provide the customer with recommendations to purchase items from alternate entities at a reduced aggregate metric, such as a reduced aggregate cost. The program may be installed as an extension program that enhances a capability of a browsing application that executes on a client device. The browsing application may access websites associated with different entities while the customer is online shopping, and the program may execute as an add-on to the browsing application. The program may function as a universal electronic shopping cart across a plurality of websites associated with a plurality of entities. As the customer is browsing through different websites, the program may provide an option to add items to the universal electronic shopping cart. As the items are being added, the program may identify a combination of entities (which may include a single entity) that provide the items for sale. The program may access a database that stores real-time prices (or near real-time prices) for items from different entities, and may perform various metric comparisons (e.g., cost comparisons) for items between different entities to identify the combination of entities that provide the items for sale with a reduced aggregate metric. The reduced aggregate metric may include a reduced aggregate item metric (e.g., a reduced aggregate item cost) and a reduced shipping metric (e.g., a reduced shipping cost), as compared to other combinations of entities. As a result, while the customer is online shopping, the customer may be notified of other entities that provide the same items for sale with the reduced aggregate metric.

In some implementations, the universal shopping cart may not be associated with a particular entity. Rather, the universal shopping cart may be available while the plurality of websites associated with a plurality of entities are accessed through the client device. Rather than adding an item to a cart associated with a particular entity, the item may be added to the universal shopping cart, which may span across the plurality of entities. While a website is being accessed, the program may operate as a background process to identify entities that provide the items for sale with the reduced aggregate metric. The customer may be unaware of the background process of identifying the entities. The universal shopping cart, when accessed via a user interface of the client device, may display a list of added items, a list of original entities associated with the added items, and an original aggregate metric associated with the added items. The universal shopping cart may further display a recommendation of alternate entities from which the items may be purchased and a new aggregate metric associated with purchasing the items from the alternate entities. As a result, the customer may be presented with an option to purchase the items from alternate entities, thereby reducing an aggregate metric.

As an example, the customer may add the $200 microwave, the $50 trash can, the $100 rug, and the $100 chair to the universal shopping cart. The customer may add these four separate items being offered from four separate entities. An initial aggregate item metric is $450 and an initial aggregate shipping metric is $50. The program may identify a fifth entity, that was not initially associated with any of the four items, that offers all four items for a same aggregate item metric of $450 but with an aggregate shipping metric of $0. In other words, the fifth entity may provide all four items with free shipping. The program may provide a notification that recommends the customer to purchase all four items from the fifth entity. The program may provide an option for the customer to purchase the four items from the fifth entity. As a result, the customer may be presented with alternate entities that offer the same items for sale with a reduced aggregate metric. The reduced aggregate metric may be based on a reduced aggregate item metric and/or a reduced shipping metric, as compared to the four separate entities initially selected.

In some implementations, the program associated with the browsing application may enable the customer to be notified of other entities that provide the same items for sale. The program may quickly search a plurality of data stores and other sources to identify entities that provide the items for sale at a reduced metric, thereby relieving the customer of having to manually search multiple websites associated with multiple entities to find reduced prices for items. The program may compare metrics between the entities and recommend a combination of entities that provide the items for sale at a reduced metric as compared to other entities. In some cases, the program may identify a single entity that provides multiple items for sale, and by using fewer entities when purchasing the items, an overall metric may be reduced due to reduced shipping metrics. Further, using fewer entities may result in multiple items being able to be combined in a same package, thereby reducing an overall environmental impact associated with online shopping.

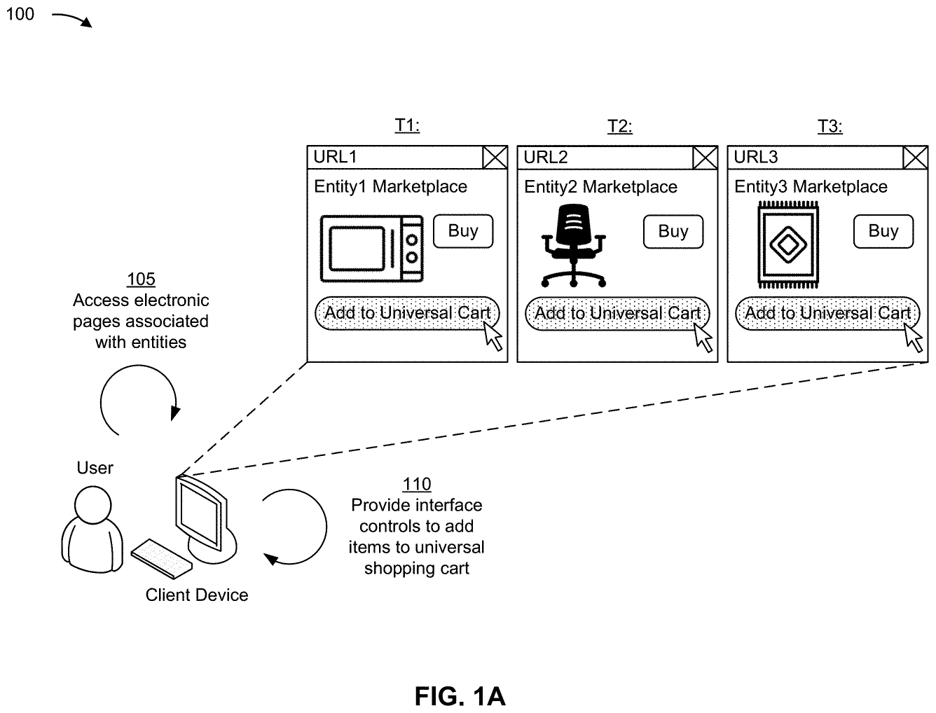

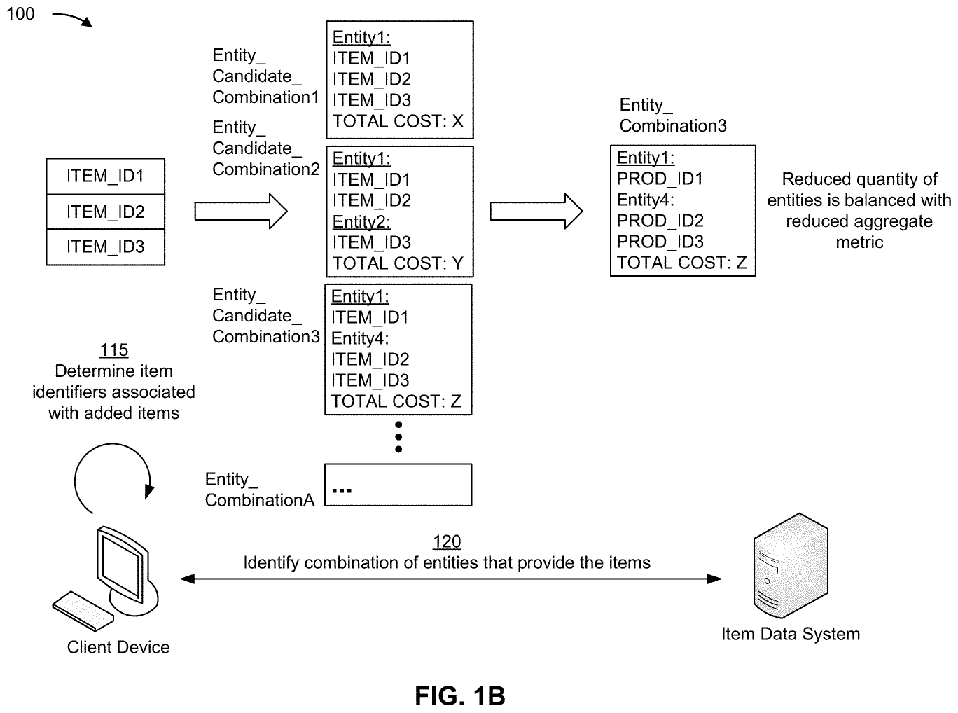

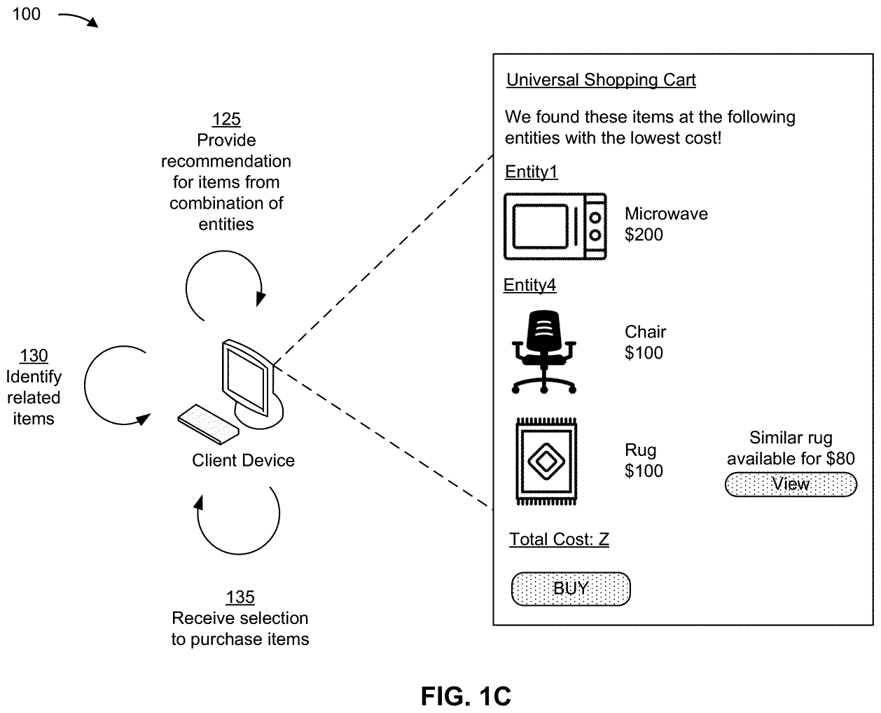

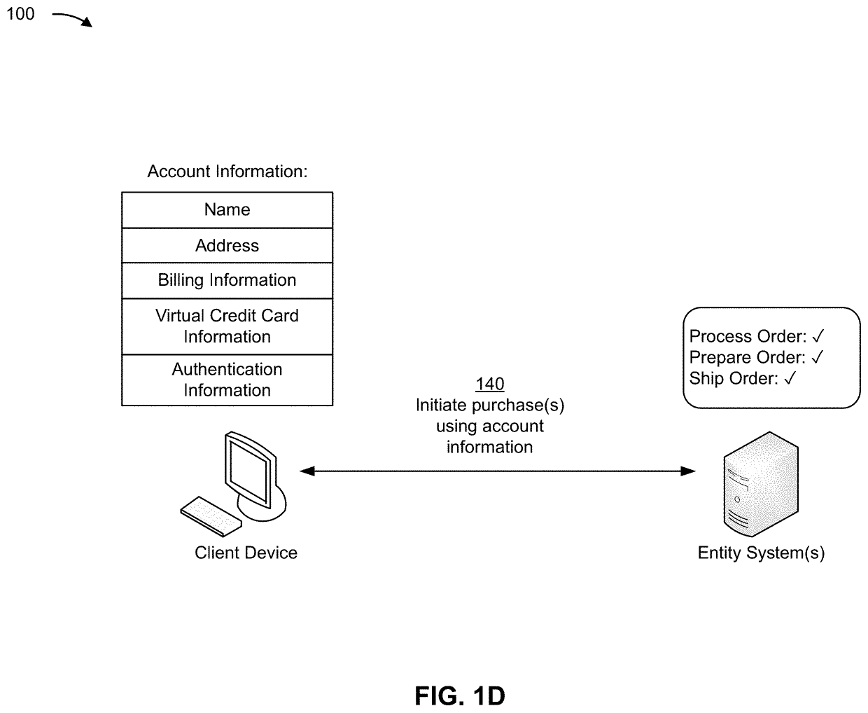

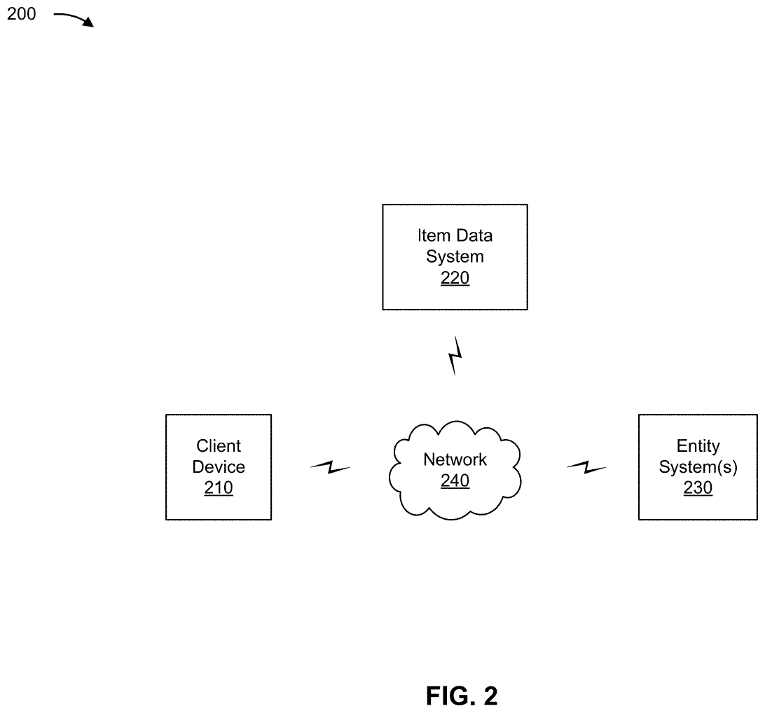

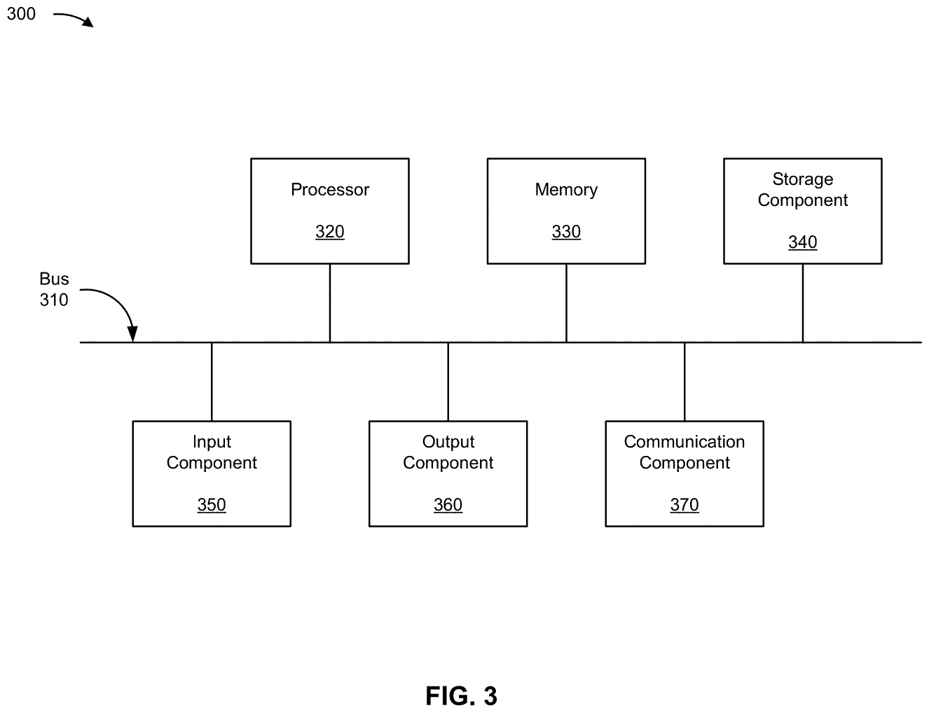

FIGS. 1A-1D are diagrams of an example implementation 100 related to providing entity recommendations for items. As shown in FIGS. 1A-1D, example implementation 100 includes a client device, an item data system, and one or more entity systems. These devices are described in more detail in connection with FIGS. 2 and 3.

As shown in FIG. 1A, and by reference number 105, the client device may access electronic pages associated with a plurality of entities, such as merchants. The client device may execute a browsing application to access the electronic pages. The electronic pages may be part of websites that are associated with the entities. For example, each entity may be associated with a website that includes a collection of electronic pages. The electronic pages may display items for sale, which may include products or services. A user associated with the client device may access the electronic pages for online shopping.

As an example, the client device may access a first website associated with an electronics entity. The client device may access a first electronic page associated with the first website that displays a microwave for sale. The client device may access a second website associated with a first retail entity. The client device may access a second electronic page associated with the second website that displays a chair for sale. The client device may access a third website associated with a second retail entity. The client device may access a third electronic page associated with the third website that displays a rug for sale.

As shown by reference number 110, a program that executes on the client device may provide interface controls to add items displayed on electronic pages to a universal shopping cart. The program may be installed as an extension program that enhances a capability of the browsing application that executes on the client device. The program may execute as an add-on to the browsing application. In some cases, the program may be a web browser-based plugin or a standalone applet. The program may determine when an item is displayed for sale on an electronic page. The program may analyze source code associated with the electronic page or perform other actions to determine when an item is displayed for sale on the electronic page. The program may generate an interface control (e.g., a selectable icon, a link, and/or a button) for display next to the item, and the interface control may allow the item to be added to the universal shopping cart. When the browsing application accesses an electronic page that does not display an item for sale, the program may not provide an interface control for display on that electronic page.

In some implementations, a user interface associated with the browsing application may display the electronic page that shows the item for sale and the interface control associated with the item. When the interface control is selected via the user interface, the item associated with the interface control may be added to the universal shopping cart. The interface control to add the item to the universal shopping cart may be separate from other interface controls (e.g., icons, buttons, and/or links) on the electronic page that are associated with the entity. For example, the electronic page that shows the item for sale may display both a first interface control to buy the item from the entity and a second interface control to add the item to the universal shopping cart, where the second interface control may be provided by the program associated with the browsing application.

In some implementations, the program may receive an indication that the interface controls have been selected. For example, when the interface controls are selected via the user interface associated with the browsing application, the program may be notified and the program may add the items associated with the interface controls to the universal shopping cart.

In some implementations, the program may identify items on electronic pages, such as a first item, a second item, and a third item. The program may provide interface controls to be associated with the items, such as a first interface control for the first item, a second interface control for the second item, and a third interface control for the third item. The program may associate entities with the items, where the entities may be include merchants that provide the items for sale. For example, the program may associate the first item with a first entity, the second item with a second entity, and the third item with a third entity. The first interface control may be displayed on a first electronic page associated with the first entity, the second interface control may be displayed on a second electronic page associated with the second entity, and the third interface control may be displayed on a third electronic page associated with the third entity. The program may receive an indication of a selection of the first interface control, the second interface control, and the third interface control, and based on the indication, the program may add the first item, the second item, and the third item to a universal shopping cart maintained by the program.

As an example, the first electronic page may include an item name associated with the microwave, an item image, an interface control (e.g., a “Buy” option) to purchase the microwave from the electronics entity, and an interface control (e.g., a “Add to Universal Cart” option) to add the microwave to the universal shopping cart. The program may generate the interface control to add the microwave to the universal shopping cart to be displayed on the first electronic page based on detecting that the first electronic page indicates the microwave as being for sale. Similarly, the second electronic page and the third electronic page may include interface controls for the chair and the rug, respectively. In this example, at a first time (T1), the client device may visit the first electronic page and the microwave may be added to the universal shopping cart. The client device may visit the second electronic page at a second time (T2) and the third electronic page at a third time (T3) to add the chair and the rug to the universal shopping cart, respectively. The program may receive indications when the microwave, the chair, and the rug are selected to be added to the universal shopping cart, and the program may add the microwave, the chair, and the rug to the universal shopping cart.

In some implementations, the client device may access, via the user interface associated with the browsing application, the universal shopping cart to view items that have been added to the universal shopping cart. A separate window that displays the items in the universal shopping cart may be opened, and the separate window may be an overlay to an electronic page that is currently being viewed through the user interface of the browsing application. For example, the universal shopping cart may indicate that the microwave, the chair, and the rug have been added to the universal shopping cart. The universal shopping cart may further indicate an entity associated with each item and a price associated with each item when purchased from a respective entity. Separate interface controls may be provided to remove items from the universal shopping cart.

As shown in FIG. 1B, and by reference number 115, the program that executes on the client device may determine item identifiers associated with the items added to the universal shopping cart. The item identifiers may be unique identifiers that identify the items added to the universal shopping cart, and may include a product number or item number, a product code or item code, a serial number, and/or a product key or item key. An item identifier for an item may be associated with an item name, an item type, item features, and/or an item manufacturer or entity associated with the item.

In some implementations, the program may analyze electronic pages associated with the items that have been added to the universal shopping cart. The electronic pages may include item information which may include the item identifiers. For example, the program may perform a text analysis of the electronic pages to detect the item identifiers associated with the items. In other words, the program may read electronic pages that provide item information to the customer to identify the item identifiers associated with the items. An electronic page for an item may include a variety of information that describes that item, such as a brand name, an item weight, item dimensions, an item model number, special features, and/or customer review information. The program may utilize this information to determine the item identifier associated with the item.

In some implementations, the program may determine an item identifier after an item has been added to the universal shopping cart and before another electronic page for another item is accessed. For example, when the client device accesses a first electronic page, a second electronic page, and a third electronic page and adds a first item, a second item, and a third item, respectively, to the universal shopping cart, the program may determine each item identifier before a subsequently electronic page is accessed. In this example, the program may identify a first item identifier from the first electronic page displayed via the user interface of the browsing application, where the first electronic page may be associated with the first item. The program may identify a second item identifier from the second electronic page displayed via the user interface of the browsing application, where the second electronic page may be associated with the second item. The program may identify a third item identifier from the third electronic page displayed via the user interface of the browsing application, where the third electronic page may be associated with the third item.

As an example, the program may determine a first item identifier (e.g., ITEM_ID1) associated with the microwave added to the universal shopping cart. The program may determine a second item identifier (e.g., ITEM_ID2) associated with the chair added to the universal shopping cart. The program may determine a third item identifier (e.g., ITEM_ID3) associated with the rug added to the universal shopping cart.

As shown by reference number 120, the program may identify a combination of entities that provide items added to the universal shopping cart for sale with a reduced aggregate metric as compared to another combination of entities. A combination of entities that provide the items for sale may include one entity or more than one entity. The reduced aggregate metric may be based on an aggregate item metric and/or an aggregate shipping metric.

In some implementations, the program may access an item data system to identify the combination of entities. The item data system may provide current prices of items being sold by a plurality of entities. The program may query the item data system using the item identifiers associated with the items. The program may send a query that indicates the item identifiers associated with the items. The item data system may output a listing of entities that provide items, associated with the item identifiers, for sale. The listing may indicate, for each item, an entity that provides the item with an aggregate metric, which may include an item metric (e.g., an item cost) and a shipping metric (e.g., a shipping cost) associated with purchasing the item from the entity. The program may form, from the listing of entities, candidate combinations of entities to provide the items for sale. The program may identify, from the candidate combinations of entities, the combination of entities that provide the items for sale with the reduced aggregate metric as compared to other combinations of entities. The combination of entities may be a single entity or multiple entities that provide the items for sale with the reduced aggregate metric.

The combination of entities selected from the candidate combination of entities may include a balance between a reduced quantity of entities and the reduced aggregate metric as compared to other combinations of entities. Reducing the quantity of entities may reduce a shipping metric and an overall environmental impact associated with transporting the items, since multiple items from a same entity may be packaged and transported together, thereby reducing the shipping metric and the overall environmental impact. As a result, when multiple items are offered by a same entity for a comparable metric as compared to purchasing the multiple items from multiple entities, the combination of entities may include the same entity as opposed to the multiple entities.

In some implementations, the program may access multiple item data systems to identify the combination of entities. Each item data system may provide current prices of items being sold by the plurality of entities. The item data systems may be maintained by third parties and may not be affiliated with the plurality of entities, or individual item data systems may be maintained by associated entities. In other words, a particular entity may provide access to an item data system associated with that entity, where the item data system may be accessed to determine real-time prices for items provided by that entity.

In some implementations, the entities indicated in the listing of entities may correspond with the entities associated with the electronic pages displaying items that were added to the universal shopping cart. Alternatively, the entities indicated in the listing of entities may not correspond with the entities associated with the electronic pages displaying items that were added to the universal shopping cart. In other words, the entities indicated in the listing of entities may or may not correspond with the entities associated with the electronic pages accessed by the client device to add the items to the universal shopping cart.

As an example, the program may send a query to the item data system that indicates the first item identifier (e.g., ITEM_ID1) associated with the microwave added to the universal shopping cart, the second item identifier (e.g., ITEM_ID2) associated with the chair added to the universal shopping cart, and the third item identifier (e.g., ITEM_ID3) associated with the rug added to the universal shopping cart. Initially, the microwave may be associated with the first entity, the chair may be associated with the second entity, and the rug may be associated with the third entity. The item data system may search a database that stores current prices (e.g., real-time prices) of items being sold by the plurality of entities. The plurality of entities may include the first entity, the second entity, the third entity, and other entities that are initially not associated with the items added to the universal shopping cart.

In the example, the item data system may indicate, as an output, a listing of entities that provide the first item, the second item, and the third item for sale. For example, the item data system may indicate entities that provide the first item for sale and an associated metric for each entity. The item data system may indicate entities that provide the second item for sale and an associated metric for each entity. The item data system may indicate entities that provide the third item for sale and an associated metric for each entity. The program, based at least in part on the output, may determine a first candidate combination of entities with a first aggregate metric. The first candidate combination of entities may include the first entity providing the first item, the second item, and the third item at an aggregate metric. The program, based at least in part on the output, may determine a second candidate combination of entities with a second aggregate metric. The second candidate combination of entities may include the first entity providing the first item and the second item, and the second entity providing the third item. The program, based at least in part on the output, may determine a third candidate combination of entities with a third aggregate metric. The third candidate combination of entities may include the first entity providing the first item, and a fourth entity providing the third item. The program may compare the first aggregate metric associated with the first candidate combination of entities, the second aggregate metric associated with the second candidate combination of entities, and the third aggregate metric associated with the third candidate combination of entities, and the program may select the third candidate combination of entities as the combination of entities to provide the items. The combination of entities selected from the candidate combination of entities may include a balance between a reduced quantity of entities and a reduced aggregate metric as compared to other candidate combinations of entities.

In some implementations, the reduced aggregate metric may include a reduced aggregate item cost and a reduced aggregate shipping cost. The reduced aggregate shipping cost for items from the combination of entities may be based on a location associated with an Internet Protocol (IP) address of the client device and/or or a registered shipping address associated with the user of the client device. In other words, an aggregate shipping cost, which may be used to determine the combination of entities from the candidate combination of entities, may consider the IP address of the client device and/or the registered shipping address.

As shown in FIG. 1C, and by reference number 125, the program that executes on the client device may provide a recommendation to initiate a transaction for the items from the combination of entities. In other words, the recommendation may be to purchase the items from the combination of entities. The recommendation may be viewed via the user interface of the browsing application when the universal shopping cart is selected and/or expanded via the user interface of the browsing application. The recommendation may indicate that the combination of entities may provide the items at the reduced aggregate metric as compared to the entities associated with the electronic pages accessed by the client device to add the items to the universal shopping cart.

As an example, the universal shopping cart may provide a recommendation that indicates that a combination of entities has been found for the user to purchase the items at the reduced aggregate metric. The universal shopping cart may indicate that the first entity provides the microwave at $200, and the fourth entity provides the chair and the rug at $100 and $100, respectively. The universal shopping cart may indicate that the microwave, the chair, and the rug may be associated with free shipping, which may result in an aggregate metric for the microwave, the chair, and the rug when purchased from the first entity and the fourth entity being less than an aggregate metric associated with other entities. Further, the recommendation may indicate that the combination of the first entity and the fourth entity may provide the microwave, the chair, and the rug at the reduced aggregate metric as compared to purchasing the microwave, the chair, and the rug from the first entity, the second entity, and the third entity, respectively. In other words, the recommendation may indicate substitute entities that were not originally associated with the microwave, the chair, and the rug when added to the universal shopping cart.

In some implementations, the program may update the recommendation to include new combinations of entities as additional items are selected via the user interface of the application and added to the universal shopping cart. For example, after a first item is added to the universal shopping cart, the program may access the item data system to identify an entity that provides the first item at a reduced aggregate metric as compared to other entities. After a second item is added to the universal shopping cart, the program may access the item data system to identify a combination of entities to provide the first item and the second item at the reduced aggregate metric as compared to other entities. The program may identify the combination of entities as a background process while the user is accessing other electronic pages for online shopping. The program may update the recommendation to include the combination of entities to provide the first item and the second item at the reduced aggregate metric. As a result, as an individual item is added to or removed from the universal shopping cart, the program may update the recommendation and provide the recommendation for display via the user interface of the client device.

As shown by reference number 130, the program may identify a related item that is similar to an item added to the universal shopping cart, and the program may include the related item in the recommendation. The program may identify the related item based on an item identifier associated with the item added to the universal shopping cart. The program may identify, based on the item identifier, item tags associated with the item added to the universal shopping cart. The program may identify the item tags using the item data system or another data system that stores information on a plurality of items and corresponding item tags. The item tags may define a brand name associated with the item added to the universal shopping cart, item dimensions associated with the item added to the universal shopping cart, and/or an item model number associated with the item added to the universal shopping cart. The program may identify, from the item data system or another data system, similar items with item tags that correspond to the item tags associated with the item added to the universal shopping cart. As a result, the program may identify the similar item in relation to the item added to the universal shopping cart. The similar item may have a cost that is within a threshold of the item added to the universal shopping cart, item features that are similar to the item added to the universal shopping cart, and/or a customer rating that is similar to the item added to the universal shopping cart. The similar item may be a substitute for the item added to the universal shopping cart.

In some implementations, the recommendation may include items that were added to the universal shopping cart and/or similar items that serve as a replacement to the items that were added to the universal shopping cart. In other words, the recommendation may be for items that the user added to the universal shopping cart and for replacement items that are similar to some of the items added to the universal shopping cart. A combination of entities may provide the items and the similar items at a reduced aggregate metric as compared to other combinations of entities.

As an example, the universal shopping cart may provide a recommendation that indicates the first entity to provide the microwave at $200, and the fourth entity to provide the chair and the rug at $100 and $100, respectively. However, the universal shopping cart may indicate that a similar rug is available from the fourth entity for $80. The similar rug may have similar features to the rug that was added to the universal shopping cart, but the similar rug may be available for the reduced cost of $80. The similar rug for $80 may be selected to replace the rug for $100. Alternatively, the recommendation for the similar rug for $80 may be ignored and the rug for $100 may remain in the universal shopping cart.

As shown by reference number 135, the program may receive a selection to purchase items indicated in the recommendation. The selection to purchase the items may be received via the user interface of the browsing application. The items indicated in the recommendation may include the items originally added to the universal shopping cart and/or the similar items.

As an example, the program may receive a selection to purchase the microwave from the first entity, and to purchase the chair and the rug from the fourth entity. In this example, the similar rug may not be purchased from the fourth entity.

As shown in FIG. 1D, and by reference number 140, the program may initiate a transaction for the items from the combination of entities using account information associated with each entity in the combination of entities. In other words, the program may initiate a purchase of the items added to the universal shopping cart from the combination of entities using the account information. The account information for each entity may be available based on previous interactions with respective entities in the combination of entities. The program may initiate the transaction with each individual entity system corresponding to each entity in the combination of entities. The program may place an order on behalf of the user associated with the client device for the items. The program may place the order by sending an order request to each entity system. The entity system may fulfill the transaction based on the order request. For example, the entity system may process the order, prepare the order, and/or ship items associated with the order.

In some implementations, the account information may include stored account information for a particular entity. The account information may include a name associated with the user, an address associated with the user, billing information (e.g., credit card number) associated with the user, virtual credit card information (e.g., a credit card number assigned to the user that is specific for that entity and is not valid for use with other entities), and/or authentication information (e.g., a username, a password, and/or security questions and answers).

In some implementations, the program may automatically place the order on behalf of the user with each entity system without user input, thereby reducing a time spent by the user while online shopping. The program may determine the combination of entities, and then place one or more orders for items with the entity systems associated with entities in the combination of entities. In some implementations, the entities may have been previously used by the user, so the account information associated with the entities may be stored by the program. As an example, when the combination of entities includes a single entity, the program may place a single order on behalf of the user with a single entity system. As another example, when the combination of entities includes multiple entities that each correspond to one or more items, the program may place multiple orders on behalf of the user with the multiple entities, thereby reducing a time spent by the user.

As an example, when the program receives a selection of the recommendation indicating that the first entity provides the microwave for $200 and the fourth entity provides the chair and the rug for $100 and $100, respectively, the program may initiate a first order for the microwave with a first entity system associated with the first entity. The program may send a first order request on behalf of the user for the microwave to the first entity system. The program may send the first order request based on stored account information associated with the first entity system. Further, the program may initiate a second order for the chair and the rug with a fourth entity system associated with the fourth entity. The program may send a second order request on behalf of the user for the chair and the rug to the fourth entity system. The program may send the second order request based on stored account information associated with the fourth entity system. In some implementations, the first entity system and the fourth entity system may prepare the first order and the second order, respectively, for fulfillment for the user associated with the user device.

In the example, the client device may access the first electronic page to add the microwave to the universal shopping cart, the second electronic page to add the chair to the universal shopping cart, and the third electronic page to add the rug to the universal shopping cart. Rather than manually checking out at all three websites, the program that operates the universal shopping cart may automatically place orders on behalf of the user with the first entity that offers the microwave and the fourth entity that offers the chair and the rug.

In some implementations, the program that executes on the client device and that is associated with the browsing application that executes on the client device may provide the interface controls to add items shown on electronic pages to the universal shopping cart, determine the item identifiers associated with the items added to the universal shopping cart, identify the combination of entities that provide the items at the reduced aggregate metric as compared to other entities, provide the recommendation for the items from the combination of entities, and initiate transactions for the items. The program may execute locally on the client device and calculations may be performed locally on the client device. The program may perform these operations as a background process and these operations may be transparent to the user associated with the client device. In other words, the user may continue browsing electronic pages associated with entities and adding items to the universal shopping cart, while the program determines the combinations of entities.

Alternatively, the program may communicate with an external system (e.g., a system that executes in a cloud computing system). In this case, the external system may identify the combination of entities that provide the items at the reduced aggregate metric as compared to other entities. The external system may indicate the combination of entities to the client device. By offloading some of the calculations to the external system, a processing load on the client device may be reduced.

As indicated above, FIGS. 1A-1D are provided as an example. Other examples may differ from what is described with regard to FIGS. 1A-1D. The number and arrangement of devices shown in FIGS. 1A-1D are provided as an example. In practice, there may be additional devices, fewer devices, different devices, or differently arranged devices than those shown in FIGS. 1A-1D. Furthermore, two or more devices shown in FIGS. 1A-1D may be implemented within a single device, or a single device shown in FIGS. 1A-1D may be implemented as multiple, distributed devices. Additionally, or alternatively, a set of devices (e.g., one or more devices) shown in FIGS. 1A-1D may perform one or more functions described as being performed by another set of devices shown in FIGS. 1A-1D.

FIG. 2 is a diagram of an example environment 200 in which systems and/or methods described herein may be implemented. As shown in FIG. 2, environment 200 may include a client device 210, an item data system 220, one or more entity systems 230, and a network 240. Devices of environment 200 may interconnect via wired connections, wireless connections, or a combination of wired and wireless connections.

The client device 210 includes one or more devices capable of receiving, generating, storing, processing, and/or providing information associated with providing entity recommendations for items, as described elsewhere herein. The client device 210 may include a communication device and/or a computing device. For example, the client device 210 may include a wireless communication device, a phone such as a smart phone, a mobile phone or a video phone, a user equipment, a laptop computer, a tablet computer, a desktop computer, or a similar type of device. In some implementations, the client device 210 may be used to connect to each of a plurality of virtual sessions associated with the aggregated virtual session.

The item data system 220 includes one or more devices capable of receiving, generating, storing, processing, providing, and/or routing information associated with providing entity recommendations for items, as described elsewhere herein. The item data system 220 may include a communication device and/or a computing device. For example, the item data system 220 may include a server, such as an application server, a client server, a web server, a database server, a host server, a proxy server, a virtual server (e.g., executing on computing hardware), or a server in a cloud computing system. In some implementations, the item data system 220 includes computing hardware used in a cloud computing environment.

An entity system 230 includes one or more devices capable of receiving, generating, storing, processing, providing, and/or routing information associated with providing entity recommendations for items, as described elsewhere herein. The entity system 230 may include a communication device and/or a computing device. For example, the entity system 230 may include a database, a server, a database server, an application server, a client server, a web server, a host server, a proxy server, a virtual server (e.g., executing on computing hardware), a server in a cloud computing system, a device that includes computing hardware used in a cloud computing environment, or a similar type of device. The entity system 230 may communicate with one or more other devices of environment 200, as described elsewhere herein.

The network 240 includes one or more wired and/or wireless networks. For example, the network 240 may include a cellular network, a public land mobile network, a local area network, a wide area network, a metropolitan area network, a telephone network, a private network, the Internet, and/or a combination of these or other types of networks. The network 240 enables communication among the devices of environment 200.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of environment 200 may perform one or more functions described as being performed by another set of devices of environment 200.

FIG. 3 is a diagram of example components of a device 300, which may correspond to the client device 210, the item data system 220, and/or the one or more entity systems 230. In some implementations, the client device 210, the item data system 220, and/or the one or more entity systems 230 may include one or more devices 300 and/or one or more components of device 300. As shown in FIG. 3, device 300 may include a bus 310, a processor 320, a memory 330, a storage component 340, an input component 350, an output component 360, and a communication component 370.

Bus 310 includes a component that enables wired and/or wireless communication among the components of device 300. Processor 320 includes a central processing unit, a graphics processing unit, a microprocessor, a controller, a microcontroller, a digital signal processor, a field-programmable gate array, an application-specific integrated circuit, and/or another type of processing component. Processor 320 is implemented in hardware, firmware, or a combination of hardware and software. In some implementations, processor 320 includes one or more processors capable of being programmed to perform a function. Memory 330 includes a random access memory, a read only memory, and/or another type of memory (e.g., a flash memory, a magnetic memory, and/or an optical memory).

Storage component 340 stores information and/or software related to the operation of device 300. For example, storage component 340 may include a hard disk drive, a magnetic disk drive, an optical disk drive, a solid state disk drive, a compact disc, a digital versatile disc, and/or another type of non-transitory computer-readable medium. Input component 350 enables device 300 to receive input, such as user input and/or sensed inputs. For example, input component 350 may include a touch screen, a keyboard, a keypad, a mouse, a button, a microphone, a switch, a sensor, a global positioning system component, an accelerometer, a gyroscope, and/or an actuator. Output component 360 enables device 300 to provide output, such as via a display, a speaker, and/or one or more light-emitting diodes. Communication component 370 enables device 300 to communicate with other devices, such as via a wired connection and/or a wireless connection. For example, communication component 370 may include a receiver, a transmitter, a transceiver, a modem, a network interface card, and/or an antenna.

Device 300 may perform one or more processes described herein. For example, a non-transitory computer-readable medium (e.g., memory 330 and/or storage component 340) may store a set of instructions (e.g., one or more instructions, code, software code, and/or program code) for execution by processor 320. Processor 320 may execute the set of instructions to perform one or more processes described herein. In some implementations, execution of the set of instructions, by one or more processors 320, causes the one or more processors 320 and/or the device 300 to perform one or more processes described herein. In some implementations, hardwired circuitry may be used instead of or in combination with the instructions to perform one or more processes described herein. Thus, implementations described herein are not limited to any specific combination of hardware circuitry and software.

The number and arrangement of components shown in FIG. 3 are provided as an example. Device 300 may include additional components, fewer components, different components, or differently arranged components than those shown in FIG. 3. Additionally, or alternatively, a set of components (e.g., one or more components) of device 300 may perform one or more functions described as being performed by another set of components of device 300.

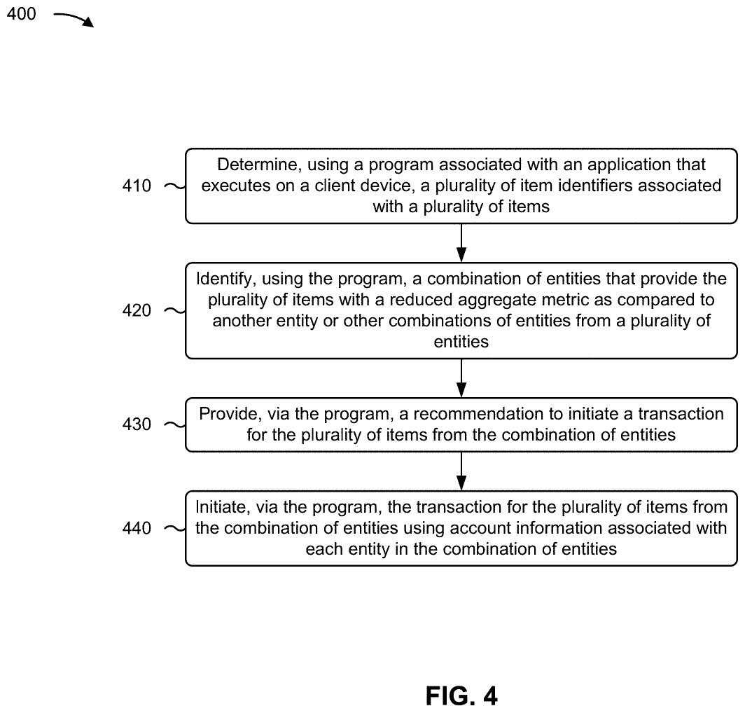

FIG. 4 is a flowchart of an example process 400 associated with providing entity recommendations for items. In some implementations, one or more process blocks of FIG. 4 may be performed by a system (e.g., client device 210, item data system 220, and/or one or more entity systems 230). In some implementations, one or more process blocks of FIG. 4 may be performed by another device or a group of devices separate from or including the system, such as client device 210, item data system 220, and/or one or more entity systems 230. Additionally, or alternatively, one or more process blocks of FIG. 4 may be performed by one or more components of device 300, such as processor 320, memory 330, storage component 340, input component 350, output component 360, and/or communication component 370.

As shown in FIG. 4, process 400 may include determining, using a program associated with an application that executes on a client device, a plurality of item identifiers associated with a plurality of items (block 410). As further shown in FIG. 4, process 400 may include identifying, using the program, a combination of entities that provide the plurality of items with a reduced aggregate metric as compared to another entity or other combinations of entities from a plurality of entities (block 420). As further shown in FIG. 4, process 400 may include providing, via the program, a recommendation to initiate a transaction for the plurality of items from the combination of entities (block 430). As further shown in FIG. 4, process 400 may include initiating, via the program, the transaction for the plurality of items from the combination of entities using account information associated with each entity in the combination of entities (block 440).

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

Accordingly, the scope of the invention should be determined not by the embodiments illustrated, but by the appended claims and their equivalents.

What is claimed is:

1. A system for providing entity recommendations for items, the system comprising:
one or more memories; and
one or more processors, coupled to the one or more memories, configured to:
provide, using a program associated with an application that executes on a client device, a first interface control associated with a first item, a second interface control associated with a second item, and a third interface control associated with a third item;
associate the first item with a first entity, the second item with a second entity, and the third item with a third entity;
receive, at the program, an indication of a selection of the first interface control, the second interface control, and the third interface control;
determine, using the program, a first item identifier associated with the first item, a second item identifier associated with the second item, and a third item identifier associated with the third item;
identify, using the program, a combination of entities that provide the first item, the second item, and the third item with a reduced aggregate metric as compared to another entity or other combinations of entities from a plurality of entities;
determine that the combination of entities associated with the reduced aggregate metric includes one or more of the first entity, the second entity, the third entity, or one or more other entities;
provide, via the program, a recommendation to initiate a transaction for the first item, the second item, and the third item from the combination of entities; and
initiate, via the program, the transaction for the first item, the second item, and the third item from the combination of entities using account information associated with each entity in the combination of entities.

2. The system of claim 1, wherein:
the one or more processors, when determining the first item identifier, are configured to determine the first item identifier from a first electronic page displayed via a user interface of the application, wherein the first electronic page is associated with the first item;
the one or more processors, when determining the second item identifier, are configured to determine the second item identifier from a second electronic page displayed via the user interface of the application, wherein the second electronic page is associated with the second item; and
the one or more processors, when determining the third item identifier, are configured to determine the third item identifier from a third electronic page displayed via the user interface of the application, wherein the third electronic page is associated with the third item.

3. The system of claim 1, wherein the reduced aggregate metric includes a reduced aggregate item cost and a reduced aggregate shipping cost, and wherein the reduced aggregate shipping cost for the first item, the second item, and the third item from the combination of entities is based on one of: a location associated with an Internet Protocol address of the client device, or a registered shipping address associated with a user of the client device.

4. The system of claim 1, wherein the first interface control is displayed on a first electronic page associated with a first entity, the second interface control is displayed on a second electronic page associated with the first entity or a second entity, and the third interface control is associated with a third electronic page associated with the first entity, the second entity or a third entity, wherein the combination of entities includes one or more of the first entity, the second entity, the third entity or another entity.

5. The system of claim 1, wherein the one or more processors are further configured to:
update the recommendation with the combination of entities as additional items are selected via a user interface of the application.

6. The system of claim 1, wherein the one or more processors, when identifying the combination of entities, are configured to:
access a database that provides current prices of items from the plurality of entities, wherein the database indicates current prices for the first item, the second item and the third item; and
identify a reduced quantity of entities from the plurality of entities that provide the first item, the second item, and the third item with the reduced aggregate metric as compared to another entity or other combinations of entities.

7. The system of claim 1, wherein the one or more processors, when initiating the transaction for the first item, the second item and the third item, are configured to:
place one or more orders on behalf of a user associated with the client device for the first item, the second item and the third item from the combination of entities, wherein the account information for each entity in the combination of entities is available based on previous interactions with respective entities in the combination of entities.

8. The system of claim 1, wherein the one or more processors are further configured to:
identify one or more related items that are similar to one or more of the first item, the second item or the third item based on corresponding tags between the one or more related items and the first item, the second item or the third item; and
indicate the one or more related items in the recommendation, wherein the recommendation indicates a combination of one or more of: the first item, the second item, the third item, or the one or more related items from the combination of entities.

9. The system of claim 1, wherein the program provides a universal electronic shopping cart across a plurality of electronic pages associated with the plurality of entities, and wherein the universal electronic shopping cart is accessible via the application.

10. A method of providing entity recommendations for items, comprising:
determining, using a program associated with an application that executes on a client device, a plurality of item identifiers associated with a plurality of items;
identifying, using the program, a combination of entities that provide the plurality of items with a reduced aggregate metric as compared to another entity or other combinations of entities from a plurality of entities;
providing, via the program, a recommendation to initiate a transaction for the plurality of items from the combination of entities; and
initiating, via the program, the transaction for the plurality of items from the combination of entities using account information associated with each entity in the combination of entities.

11. The method of claim 10, wherein determining the plurality of item identifiers comprises: determining the plurality of item identifiers from one or more electronic pages displayed via a user interface of the application.

12. The method of claim 10, wherein the reduced aggregate metric includes a reduced aggregate item cost and a reduced aggregate shipping cost, and wherein the reduced aggregate shipping cost for the plurality of items from the combination of entities is based on one of: a location associated with an Internet Protocol address of the client device, or a registered shipping address associated with a user of the client device.

13. The method of claim 10, wherein identifying the combination of entities comprises:
accessing a database that provides real-time prices of items from the plurality of entities, wherein the database indicates real-time prices for each of the plurality of items; and
identifying a reduced quantity of entities from the plurality of entities that provide the plurality of items with the reduced aggregate metric as compared to another entity or other combinations of entities.

14. The method of claim 10, wherein initiating the transaction for the plurality of items comprises:
placing one or more orders on behalf of a user associated with the client device for the plurality of items from the combination of entities, wherein the account information for each entity in the combination of entities is available based on previous interactions with respective entities in the combination of entities.

15. The method of claim 10, further comprising:
identifying a related item that is similar to one or more of the plurality of items based on corresponding tags between the related item and the one or more of the plurality of items; and
indicating the related item in the recommendation, wherein the recommendation indicates the related item as a replacement for one of the plurality of items.

16. The method of claim 10, wherein the program provides a universal electronic shopping cart across a plurality of electronic pages associated with the plurality of entities, and wherein the universal electronic shopping cart is accessible via the application.

17. A non-transitory computer-readable medium storing a set of instructions, the set of instructions comprising:
one or more instructions that, when executed by one or more processors of a device, cause the device to:
identify, using a program associated with an application that executes on a client device, an item indicated on an electronic page associated with an entity;
provide, using the program, an interface control via a user interface associated with the application, wherein the interface control is associated with the item indicated on the electronic page;
receive, at the program, an indication of a selection of the interface control associated with the item;
determine, using the program, an item identifier associated with the item based on information describing the item on the electronic page;
identify, using the program, an entity that provides the item with a reduced metric as compared to another entity from a plurality of entities;
provide, via the program, a recommendation to initiate a transaction for the item from the entity; and
update, using the program, the recommendation to include a plurality of items based on additional item identifiers detected via selections of interface controls associated with the additional items, wherein the recommendation indicates a combination of entities that provide the plurality of items with a reduced aggregate metric as compared to another entity or other combinations of entities from the plurality of entities.

18. The non-transitory computer-readable medium of claim 17, wherein the one or more instructions, when executed by the one or more processors, further cause the device to:
initiate, via the program, the transaction for the plurality of items from the combination of entities using account information associated with each entity in the combination of entities.

19. The non-transitory computer-readable medium of claim 17, wherein the one or more instructions, that cause the device to identify the entity, cause the device to: identify the entity based on access to a database that provides current prices of items from the plurality of entities.

20. The non-transitory computer-readable medium of claim 17, wherein the program provides a universal electronic shopping cart across a plurality of electronic pages associated with the plurality of entities, and wherein the universal electronic shopping cart is accessible via the application.
